(19) United States
(12) Patent Application Publication
(10) Pub. No.: US 2005/0243799 A1
(43) Pub. Date: Nov. 3, 2005

(54) System and method for securing SS7 networks

(76) Inventors: Juha Saaskilahti, Helsinki (FI); Karl-Johan Wiren, Vanda (FI); Reijo Pekkala, Espoo (FI)

Correspondence Address: ERICSSON INC., 6300 LEGACY DRIVE, M/S EVR C11, PLANO, TX, 75024, US

(21) Appl. No.: 10/828,071

(22) Filed: Apr. 20, 2004

(51) Int. Cl. H04L 12/66

(52) U.S. Cl. 370/352; 379/221.08

(57) ABSTRACT

A SS7 network component (e.g., Signaling Transfer Point (STP)) and a method are described herein which function to add a security parameter and if desired encrypt the user data in a traditional Signaling Connection Control Part (SCCP) message to create a secure SCCP message that can be safely transmitted through one or more transport SS7 networks to a destination SS7 network. The destination SS7 network has a SS7 network component (e.g., STP) that can function to transform the secure SCCP message back into the traditional SCCP message.

### BACKGROUND OF THE INVENTION

1. Field of the Invention

The present invention relates in general to protecting traffic within Signaling System No. 7 (SS7) networks and more particularly to a SS7 network component (e.g., Signaling Transfer Point (STP)) and a method for protecting Signaling Connection Control Part (SCCP) messages from being spoofed and/or eavesdropped.

2. Description of Related Art

The Third Generation Partnership Project (3GPP) has standardized a number of protocols with the aim of providing globally applicable third generation mobile systems based upon the evolution of second generation Global System for Mobile Communication (GSM) technology.

As a result, the 3G network operators/service providers continue to use SS7 networks to exchange signalling information between signalling nodes of the various core networks of their mobile systems and to exchange signalling information with signalling nodes of third party networks such as Public Switched Telephone Networks (PSTNs).

A particular concern of 3GPP has been the securing of network traffic, given that the old model of a few trusted service providers freely exchanging signaling traffic with each other no longer applies. This is because a large number of new and sometimes unreliable service providers are expected to enter into the business of supplying telecommunication services to businesses and consumers. As such, a given service provider will no longer be able to rely on the assumption that other service providers will not try to “attack” their network either deliberately or inadvertently. For instance, an unreliable service provider can simply pay a modest fee to gain access to SS7 networks and then can spoof traffic and eavesdrop on messages in the SS7 networks.

To help address this concern, the 3GPP has standardized a protocol called “MAP application layer security” (MAPsec) which is described in the standard entitled “3GPP TS 33.200 v5.1.0 (2002-12) (release 5)”. Unfortunately, the MAPsec protocol protects only part of the MAP operations and leaves other protocols untouched, and unsafe. Moreover, the implementation of the MAPsec protocol is expensive and complicated. Accordingly, there is a need for new method that can protect messages like SCCP messages that are transmitted within SS7 networks. This need and other needs are satisfied by the method and the SS7 network component (e.g., STP) of the present invention.

### BRIEF DESCRIPTION OF THE INVENTION

The present invention includes a SS7 network component (e.g., STP) and a method which function to add a security parameter and if desired encrypt the data in a traditional SCCP message to create a secure SCCP message that can be safely transmitted through one or more transport SS7 networks to a destination SS7 network. The destination SS7 network has a SS7 network component (e.g., STP) that can function to transform the secure SCCP message back into the traditional SCCP message.

### BRIEF DESCRIPTION OF THE DRAWINGS

A more complete understanding of the present invention may be obtained by reference to the following detailed description when taken in conjunction with the accompanying drawings wherein:

FIG. 1 is a block diagram illustrating several SS7 networks in which an originating SS7 network and a destination SS7 network both have a SS7 network component (e.g., STP) that implements a SCCPsec method in accordance with the present invention; and

FIG. 2 is a flowchart illustrating the steps of the preferred SCCPsec method for protecting a SCCP message that is transmitted from the originating SS7 network and travels through one or more transport SS7 network(s) to the destination SS7 network as shown in FIG. 1 in accordance with the present invention.

### DETAILED DESCRIPTION OF THE DRAWINGS

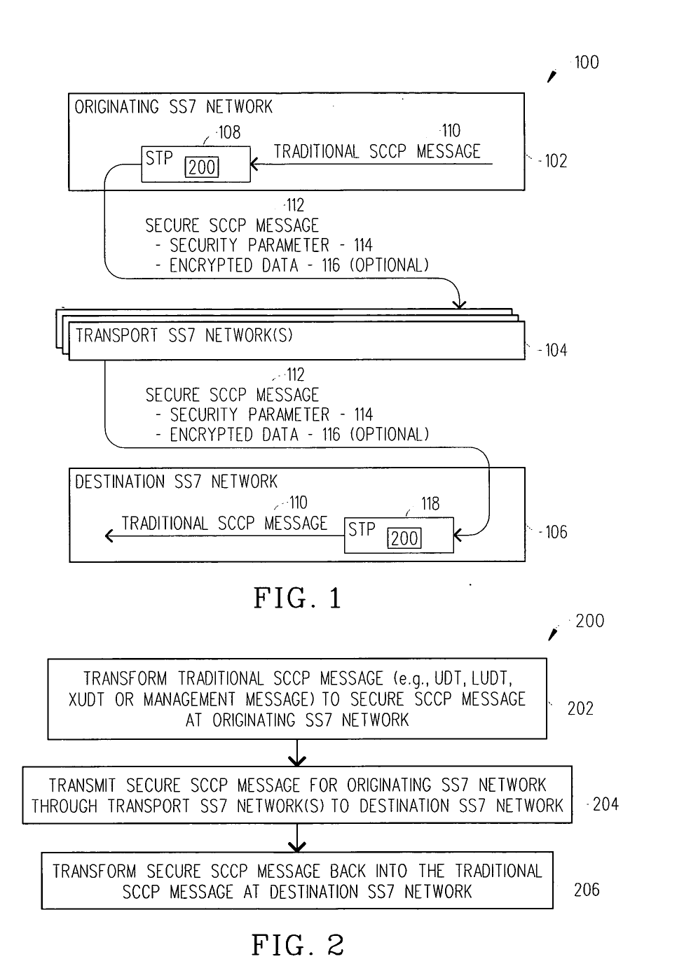

Referring to FIG. 1, there is illustrated a network 100 that includes an originating SS7 network 102, multiple transport SS7 networks 104 and a destination SS7 network 106. The originating SS7 network 102 includes a SS7 network component 108 (e.g., STP 108) that implements the SCCPsec method 200 to transform (step 202 in FIG. 2) a traditional SCCP message 110 into a secure SCCP message 112. The secure SCCP message 112 includes a security parameter 114 and encrypted user data 116 (optional). The SS7 network component 108 then transmits (step 204 in FIG. 2) the secure SCCP message 112 through one or more of the transport SS7 networks 104 to the destination SS7 network 106. The destination SS7 network 106 includes a SS7 network component 118 (e.g., STP 118) that implements the SCCPsec method 200 to transform (step 206 in FIG. 2) the secure SCCP message 112 back to the traditional SCCP message 110. A detailed discussion about the different types of SCCP messages 110 that can be secured and how those SCCP messages 110 are secured is provided below after a brief discussion about the SCCP protocol.

The SS7 network components 108 and 118 each can have a protocol stack as shown in TABLE 1:

TABLE 1

MAP (Mobile Application Part)
TCAP (Transaction Capabilities Application Part)
SCCP (Signaling Connection Control Part)
MTP1 . . . 3 (Message Transfer Part1 . . . 3)*
*SCCP protocol can also be carried over MTP3b or M3UA protocols.

In mobile networks, the most important protocol that the SCCP carries is TCAP over which MAP (for example) can be transported. Several different types of SCCP messages 110 and their associated parameter fields are listed below in TABLE 2.

TABLE 2*

| | Messages | | | | | | | | | | |
|---|---|---|---|---|---|---|---|---|---|---|---|
| Parameter field | CR | CC | CREF | RLSD | RLC | DT1 | DT2 | AK | ED | EA | RSR |
| Destination local reference | | m | m | m | m | m | m | m | m | m | m |
| number | | | | | | | | | | | |
| Source local reference | m | m | | m | m | | | | | | m |
| number | | | | | | | | | | | |
| Called party address | m | o | o | | | | | | | | |
| Calling party address | o | | | | | | | | | | |
| Protocol class | m | m | | | | | | | | | |
| Segmenting/ | | | | | | m | | | | | |
| reassembling | | | | | | | | | | | |
| Receive sequenece number | | | | | | | | m | | | |
| Sequencing/segmenting | | | | | | | m | | | | |
| Credit | o | o | | | | | | m | | | |
| Release cause | | | | m | | | | | | | |
| Return cause | | | | | | | | | | | |
| Reset cause | | | | | | | | | | | m |
| Error cause | | | | | | | | | | | |
| User data | o | o | o | o | | m | m | | m | | |
| Refusal cause | | | m | | | | | | | | |
| End of optional parameters | o | o | o | o | | | | | | | |
| Hop counter | o | | | | | | | | | | |
| Segmentation | | | | | | | | | | | |
| Importance | o | o | o | o | | | | | | | |
| Long data | | | | | | | | | | | |
| Security | | | | | | | | | | | |

| | Messages | | | | | | | | |
|---|---|---|---|---|---|---|---|---|---|
| Parameter field | RSC | ERR | IT | UDT | UDTS | XUDT | XUDTS | LUDT | LUDTS |
| Destination local reference | m | m | m | | | | | | |
| number | | | | | | | | | |
| Source local reference | m | | m | | | | | | |
| number | | | | | | | | | |
| Called party address | | | | m | m | m | m | m | m |
| Calling party address | | | | m | m | m | m | m | m |
| Protocol class | | | m | m | | m | | m | |
| Segmenting/ | | | | | | | | | |
| reassembling | | | | | | | | | |
| Receive sequenece number | | | | | | | | | |
| Sequencing/segmenting | | | m^{a)} | | | | | | |
| Credit | | | m^{a)} | | | | | | |
| Release cause | | | | | | | | | |
| Return cause | | | | | m | | m | | m |
| Reset cause | | | | | | | | | |
| Error cause | | m | | | | | | | |
| User data | | | | m | m | m | m | | |
| Refusal cause | | | | | | | | | |
| End of optional parameters | | | | | | o | o | o | o |
| Hop counter | | | | | | m | m | m | m |
| Segmentation | | | | | | o | o | o^{b)} | o |
| Importance | | | | | | o | o | o | o |
| Long data | | | | | | | | m | m |
| Security | | | | | | o | | o | |

^{a)}Information in these parameter fields are ignored if the protocol class parameter indicates class 2.
^{b)}The segmentation parameter must be included by the originating node, if MTP/MTP-3b interworking is expected.
*Reference is made to the International Telecommunication Union standard ITU-T Q.712 (07/96) entitled “Definition and Function of Signalling Connection Control Part Messages” for a more detailed description about the SCCP messages and the parameter fields shown in TABLE 2. The contents of ITU-T Q.712 are incorporated by reference herein.

The SCCP messages 110 listed in TABLE 2 are defined in more detail as follows:
CR—Connection Request Message.
CC—Connection Confirm Message.
CREF—Connection Refused Message.
RLSD—Released Message.
RLC—Release Complete Message.
DT1—Data Form 1 Message.
DT2—Data Form 2 Message.
AK—Data Acknowledgment Message.
ED—Expedited Data Message.
EA—Expedited Data Acknowledgment Message.
RSR—Reset Request Message.
RSC—Reset Confirm Message.
ERR—Protocol Data Unit Error Message.
IT—Inactivity Test Message.
UDT—Unitdata Message.
UDTS—Unitdata Service Message.
XUDT—Extended Unitdata Message.
XUDTS—Extended Unitdata Message.
LUDT—Long Unitdata Message.
LUDTS—Long Unitdata Service Message.

In accordance with the preferred embodiment of the SSCPsec method 200, the SCCP messages 110 that are protected are the connectionless messages that carry user data such as the UDT message 110, the XUDT message 110 and the LUDT message 110. As can be seen in TABLE 2, the only difference between the LUDT message 110 and the XUDT message 110 is that in the XUDT message 110 there is the ‘normal’ (mandatory) user data field, and no long data field. And, in the LUDT message 110 there. is the (mandatory) long data field, but no user data field. As can also be seen in TABLE 2, the different parameter fields in the LUDT message 110 and the XUDT message 110 are:
Called party address (mandatory)
Calling party address (mandatory)
Protocol class (mandatory)
End of optional parameters (optional)
Hop counter (mandatory)
Segmentation (optional)
Importance (optional)
User data (XUDT message 110, mandatory)/Long data (LUDT message 110, mandatory)

The SCCPsec method 200 protects the XUDT and LUDT messages 110 by including a “security” parameter 114 (with a number of parameter fields (e.g., integrity checksum) in the optional parameters field and by possibly encrypting the actual user data 116. In particular, the SS7 network component 108 (e.g., STP 108) implements SCCPsec method 200 to add the security parameter 114 and if desired encrypt the user data 116 of the XUDT and LUDT messages 110 so as to create the secure XUDT and LUDT messages 112. It should be noted that the secure XUDT and LUDT messages 112 are likely going to be segmented at the SCCP level due to the increase in the total message length because of the information associated with the security parameter 114.

The SCCPsec method 200 can also protect the UDT message 110 in a similar manner but needs to first convert the traditional UDT message 110 into a traditional LUDT or XUDT message 110. To accomplish this, the parameters of the UDT message 110 can be directly copied into equivalent parameters of the XUDT or LUDT message 110. The particular type of message that the UDT message 110 is converted into would depend on the capabilities of the lower layer narrowband or broadband signaling links. It should be noted that the security measures provided by the SCCPsec method 200 cannot be directly applied to UDT messages 110 mainly for two reasons: (1) there are no optional parameters in the message type to include the security information and adding new ones is very unlikely in the standardization; and (2) the UDT message 110 type provides no segmentation service.

The “security” parameter 114 in the secure XUDT and LUDT messages 112 (including the converted UDT messages 112) could contain the following parameter fields:
Protection (e.g., 8 bits), options:
   No encryption and no integrity protection, user data unchanged.
   Integrity protection, user data unchanged.
   Integrity protection and encryption protection, user data encrypted.
   Key management message, user data contains key management message. The key management message may be embedded into a secure SCCP message 122 so an “embedded management message indicator” can be added in the “security’ parameter 114.
   Full SCCP encapsulation (optional)(see TABLE 3).
Integrity checksum (e.g., 128/160 bits using HMAC-MD5 or HMAC-SHA-1)*. It should be noted that the integrity checksum in the preferred embodiment covers all of the other fields of the “security” parameter 114 except for the checksum itself.
   * The HMAC (RFC 2104) stands for “Keyed-Hashing for Message Authentication”, the MD5 (RFC 1321) stands for “Message Digest Algorithm” and the SHA-1 (RFC 3174) stands for “Secure Hash Algorithm”.
The Public Land Mobile Network (PLMN) Identity, to find correct keys etc (e.g., 32 bit).
UDT<->XUDT/LUDT conversion indicator.
Message sequence number (for anti-replay protection).
Future use.

It should be appreciated that the integrity protection provided by the integrity checksum in SCCPsec method 200 ensures that the secured SCCP message 112 received at the destination SS7 network 106 was not altered and did originate at the originating SS7 network 102. This helps prevent unreliable service providers from “spoofing” the secure SCCP message 112. And, the encryption protection provided by the SCCPsec method 200 ensures that only the destination SS7 network 106 which has the encryption key can read the user data if it was encrypted. This helps prevent unreliable service providers from “eavesdropping” on the secure SCCP message 112.

In accordance with another embodiment of the SCCPsec method 200, the SCCP messages 110 that are SCCP management messages 110 can also be protected. The protection of SCCP management messages 110 would help prevent malicious attacks against the management interfaces. The different types of SCCP management messages 110 that could be protected and their associated parameter fields are listed below in TABLE 3.

TABLE 3*

| | Messages | | | | | |
|---|---|---|---|---|---|---|
| Parameter fields | SSA | SSP | SST | SOR | SOG | SSC |
| SCMG format ID | m | m | m | m | m | m |
| Affected SSN^{a)} | m | m | m | m | m | m |
| Affected PC | m | m | m | m | m | m |
| Subsystem multiplicity | m | m | m | m | m | m |
| indicator^{b)} | | | | | | |
| Congestion level | | | | | | m |

^{a)}The affected SSN is equal to one if the message pertains to the SCCP itself or to the SCCP node.
^{b)}Reserved for national use.
*Reference is made to the International Telecommunication Union standard ITU-T Q.712 (07/96) entitled “Definition and Function of Signalling Connection Control Part Messages” for a more detailed description about the SCCP management messages and the parameter fields shown in TABLE 3.

The SCCP management messages 110 listed in TABLE 3 are defined in more detail as follows:
SSA—Subsystem-Allowed Message.
SSP—Subsystem-Prohibited Message.
SST—Subsystem-Status-Test Message.
SOR—Subsystem-Out-Of-Service-Request Message.
SOG—Subsystem-Out-Of-Service-Grant Message
SSC—Subsystem Congested Message.

The SCCPsec method 200 can protect a SCCP management message 110 by encapsulating it in full into the data field of the secure XUDT or LUDT message 112. In particular, the SCCPsec method 200 can generate a new secured XUDT or LUDT message 112 from the SCCP management message 110 by putting the full SCCP management message 110 in the user data/long data parameter and creating a new header and security parameter 114. The SCCPsec method 200 could also if desired encrypt the user data 116 in these secured XUDT and LUDT messages 112. The SS7 network component 118 (e.g., STP 118) at the destination SS7 network 106 could then transform/decapsulate the secured XUDT or LUDT message 112 back into the SCCP management message 110. It should also be appreciated that the SCCPsec method 200 can be used to protect key management messages in a similar fashion as the SCCP management messages 110.

In accordance with yet another embodiment of the SCCPsec method 200, a policy decision point can be added to method 200 before step 202 to determine whether a destination PLMN has also implemented the SCCPsec method 200. Because, a secure SCCP message 112 should only be sent to a PLMN that has implemented the SCCPsec method 200.

From the foregoing, it can be readily appreciated by those skilled in the art that the present invention provides a SCCPsec method 200 that adds integrity protection and encryption protection to the SCCP protocol which ensures operators that the higher layer applications related to SCCP traffic which they receive truly originated unchanged from where it claimed to originate and that the SCCP traffic has not been eavesdropped. The SCCPsec method 200 requires no changes to the existing transport SS7 networks 104. However, the SCCPsec method 200 does require minor modifications to the SS7 network components 108 and 118 (e.g., SCCP relay points/gateways, STPs) at the network boundaries of the originating and destination SS7 networks 102 and 106.

It should be noted that many components and details associated with the SS7 networks 102, 104 and 106 and STPS 108 and 118 described herein and shown in FIG. 1 are well known in the industry. Therefore, for clarity, the description provided above omitted the well known components and details that were not necessary to understand the present invention.

Following are some additional features, advantages and uses of the SCCPsec method 200 of the present invention:
The SCCPsec method 200 can secure SS7 networks more economically and with fewer modifications to the existing SS7 networks than the MAPsec method.
The implementation of the SCCP method 200 does not require the modification of fixed network protocols like the ISDN User Part (ISUP) and the Bearer Independent Call Control Protocol (BICC). However, the fixed network protocols are not protected by the SCCPsec method 200.
The SCCPsec method 200 enables operators to mutually agree on security, and implement security at one point in their networks.
In practice the SCCPsec method 200 protects most of the mobile networks' SS7 based application layer protocols. As a result, the need for MAPsec method is diminished. In addition, the SCCPsec method 200 would also be better suited for operator-to-operator configuration than the MAPsec method.

Although several embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

1. A Signaling System No. 7 (SS7) network component capable of adding a security parameter to a Signaling Connection Control Part (SCCP) message so as to create a secure SCCP message.

2. The SS7 network component of claim 1, wherein the secure SCCP message also includes encrypted data.

3. The SS7 network component of claim 1, wherein the security parameter includes the following fields:
protection options;
embedded management message indicator;
integrity checksum;
public land mobile network (PLMN) identity;
unitdata (UDT) to extended unitdata (XUDT) or long unitdata (LUDT) conversion indicator; and
message sequence number.

4. The SS7 network component of claim 3, wherein the protection options include:
no integrity protection and no encryption protection;
integrity protection and no encryption protection; and
integrity protection and encryption protection.

5. The SS7 network component of claim 1, wherein the SCCP message is an extended unitdata (XUDT) message or a long unitdata (LUDT) message.

6. The SS7 network component of claim 1, wherein if the SCCP message is a unitdata (UDT) message then that UDT message is converted into an extended unitdata (XUDT) message or a long unitdata (LUDT) message which is transformed into the secured SCCP message.

7. The SS7 network component of claim 1, wherein if the SCCP message is a SCCP management message then the SCCP management message is placed into a normal user data field of a new extended unitdata (XUDT) message or placed into a long data field of a new long unitdata (LUDT) message which is transformed into the secured SCCP message.

8. The SS7 network component of claim 1, wherein if the SCCP message is a key management message then the key management message is placed into a normal user data field of a new extended unitdata (XUDT) message or placed into a long data field of a new long unitdata (LUDT) message which is transformed into the secured SCCP message.

9. The SS7 network component of claim 1, wherein the SS7 network component is a Signaling Transfer Point (STP).

10. A method for protecting a Signaling Connection Control Part (SCCP) message so the SCCP message can be safely transmitted through at least one Signaling System No. 7 (SS7) network, said method comprising the step of:
transforming, at a SS7 network component, the SCCP message into a secure SCCP message.

11. The method of claim 10, wherein said step of transforming the SCCP message into the secure SCCP message includes:
adding a security parameter to the SCCP message.

12. The method of claim 11, wherein said step of transforming the SCCP message into the secure SCCP message further includes:
encrypting data in the SCCP message.

13. The method of claim 11, the security parameter includes the following fields:
protection options;
embedded management message indicator;
integrity checksum;
public land mobile network (PLMN) identity;
unitdata (UDT) to extended unitdata (XUDT) or long unitdata (LUDT) conversion indicator; and
message sequence number.

14. The method of claim 13, wherein the protection options include:
no integrity protection and no encryption protection;
integrity protection and no encryption protection; and
integrity protection and encryption protection.

15. The method of claim 10, wherein the SCCP message is an extended unitdata (XUDT) message or a long unitdata (LUDT) message.

16. The method of claim 10, wherein if the SCCP message is a unitdata (UDT) message then that UDT message is converted into an extended unitdata (XUDT) message or a long unitdata (LUDT) message which is transformed into the secured SCCP message.

17. The method of claim 10, wherein if the SCCP message is a SCCP management message then the SCCP management message is placed into a normal user data field of a new extended unitdata (XUDT) message or placed into a long data field of a new long unitdata (LUDT) message which is transformed into the secured SCCP message.

18. The method of claim 10, wherein if the SCCP message is a key management message then the key management message is placed into a normal user data field of a new extended unitdata (XUDT) message or placed into a long data field of a new long unitdata (LUDT) message which is transformed into the secured SCCP message.

19. A Signaling System No. 7 (SS7) network component capable of transforming a secure Signaling Connection Control Part (SCCP) SCCP message that was received into a SCCP message.

20. The SS7 network component of claim 19, wherein the secure SCCP message includes a security parameter which has the following fields:
protection options;
embedded management message indicator;
integrity checksum;
public land mobile network (PLMN) identity;
unitdata (UDT) to extended unitdata (XUDT) or long unitdata (LUDT) conversion indicator; and
message sequence number.

21. The SS7 network component of claim 20, wherein the protection options include:
no integrity protection and no encryption protection;
integrity protection and no encryption protection; and
integrity protection and encryption protection.

22. The SS7 network component of claim 19, wherein the secure SCCP message includes encrypted data.

23. The SS7 network component of claim 19, wherein the SCCP message is an extended unitdata (XUDT) message or a long unitdata (LUDT) message.

24. The SS7 network component of claim 19, wherein if the SCCP message is a unitdata (UDT) message then that UDT message was extracted from an extended unitdata (XUDT) message or a long unitdata (LUDT) message associated with the secure SCCP message.

25. The SS7 network component of claim 19, wherein if the SCCP message is a SCCP management message then that SCCP management message was extracted from a normal user data field of an extended unitdata (XUDT) message or extracted from a long data field of a long unitdata (LUDT) message associated with the secure SCCP message.

26. The SS7 network component of claim 19, wherein if the SCCP message is a key management message then that key management message was extracted from a normal user data field of an extended unitdata (XUDT) message or extracted from a long data field of a long unitdata (LUDT) message associated with the secure SCCP message.

27. The SS7 network component of claim 19, wherein the SS7 network component is a Signaling Transfer Point (STP).

28. A method for receiving a secure Signaling Connection Control Part (SCCP) message that was safely transmitted through at least one Signaling System No. 7 (SS7) network, said method comprising the step of:
transforming, at the SS7 network component, the received secure SCCP message into a SCCP message.

29. The method of claim 28, wherein the secure SCCP message includes a security parameter which has the following fields:
protection options;
embedded management message indicator;
integrity checksum;
public land mobile network (PLMN) identity;
unitdata (UDT) to extended unitdata (XUDT) or long unitdata (LUDT) conversion indicator; and
message sequence number.

30. The method of claim 29, wherein the protection options include:
no integrity protection and no encryption protection;
integrity protection and no encryption protection; and
integrity protection and encryption protection.

31. The method of claim 28, wherein the secure SCCP message includes encrypted data.

32. The method of claim 28, wherein the SCCP message is an extended unitdata (XUDT) message or a long unitdata (LUDT) message.

33. The method of claim 28, wherein if the SCCP message is a unitdata (UDT) message then that UDT message was extracted from an extended unitdata (XUDT) message or a long unitdata (LUDT) message associated with the secure SCCP message.

34. The method of claim 28, wherein if the SCCP message is a SCCP management message then that SCCP management message was extracted from a normal user data field of an extended unitdata (XUDT) message or extracted from a long data field of a long unitdata (LUDT) message associated with the secure SCCP message.

35. The method of claim 28, wherein if the SCCP message is a key management message then that key management message was extracted from a normal user data field of an extended unitdata (XUDT) message or extracted from a long data field of a long unitdata (LUDT) message associated with the secure SCCP message.
